(19) United States
(12) Patent Application Publication
(10) Pub. No.: US 2022/0020295 A1
(43) Pub. Date: Jan. 20, 2022

(54) 3D Paintball Strategy Board

(71) Applicant: Jesse Vanderpool, Richmond, VA (US)

(72) Inventor: Jesse Vanderpool, Richmond, VA (US)

(21) Appl. No.: 17/246,512

(22) Filed: Apr. 30, 2021

Related U.S. Application Data
(60) Provisional application No. 63/052,770, filed on Jul. 16, 2020.

(51) Int. Cl. G09B 29/00

(52) U.S. Cl. CPC G09B 29/001; A63F 11/0074

(57) ABSTRACT

A strategy board apparatus suited for strategic paintball play is presented. The strategy board apparatus contains a board body and at least one strategy piece. The board body comprises a mounting surface. The mounting surface traverses along the board body. The at least one strategy piece is removably attached and distributed about the mounting surface through a fastening element.

The current application claims a priority to the U.S. Provisional Patent application Ser. No. 63/052,770 filed on Jul. 16, 2020.

### FIELD OF THE INVENTION

The present invention relates generally to strategy boards. More specifically, the present invention is a strategy board suited for field sports.

### BACKGROUND OF THE INVENTION

Paintballing is not just a simple activity for recreation and leisure. Paintball can also be a competitive sport to showcase skills, accuracy, and teamwork. With many competitive players grouping into teams, players can form strategies and plans to compete and beat their competition. Paintball competitions are played on grass or turf fields with inflatable bunkers that are positioned differently at every event. Therefore, it is an objective of the present invention to provide a means that allows teams to discuss and formulate their strategies. The present invention is a strategy board that allows players to discuss and formulate strategies. The present invention will represent and mimic the field layout of interest. The present invention is portable and adaptable to any strategy setting.

### SUMMARY OF THE INVENTION

The present invention is a strategy board apparatus suited for strategic paintball play. The strategy board apparatus comprises a board body and at least one strategy piece. The board body comprises a mounting surface. The mounting surface traverses along the board body. The at least one strategy piece is removably attached and distributed about the mounting surface through a fastening element.

### BRIEF DESCRIPTION OF THE DRAWINGS

FIG. 1 is a top perspective view of the present invention in a flat configuration.

FIG. 2 is a bottom perspective view of the present invention in a flat configuration.

FIG. 3 is an exploded view of the present invention.

FIG. 4 is a top perspective view of the present invention in a folded configuration.

FIG. 5 is a perspective view of one strategy piece used in the present invention.

### DETAIL DESCRIPTIONS OF THE INVENTION

All illustrations of the drawings are for the purpose of describing selected versions of the present invention and are not intended to limit the scope of the present invention. The present invention is to be described in detail and is provided in a manner that establishes a thorough understanding of the present invention. There may be aspects of the present invention that may be practiced or utilized without the implementation of some features as they are described. It should be understood that some details have not been described in detail in order to not unnecessarily obscure focus of the invention. References herein to “the preferred embodiment”, “one embodiment”, “some embodiments”, or “alternative embodiments” should be considered to be illustrating aspects of the present invention that may potentially vary in some instances, and should not be considered to be limiting to the scope of the present invention as a whole.

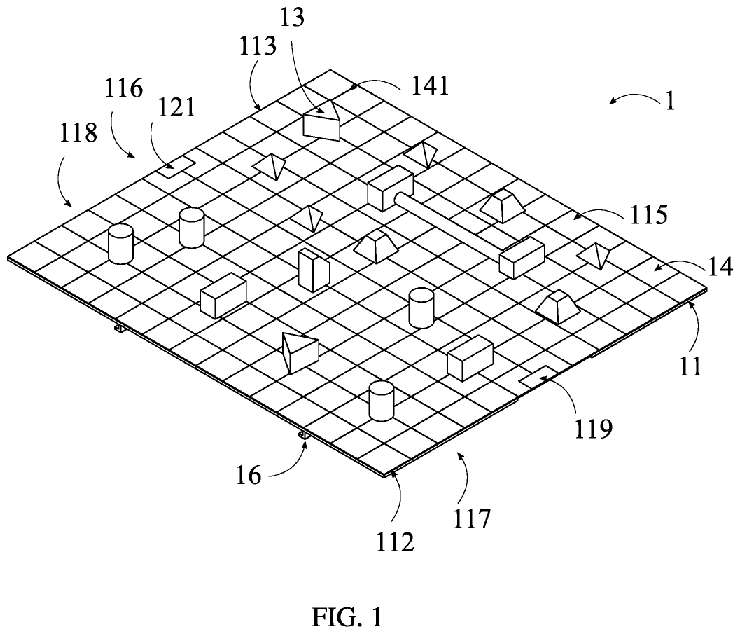

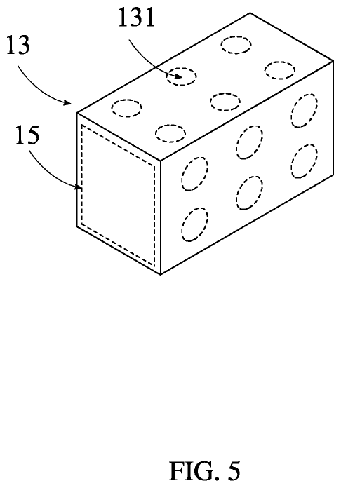

The present invention is a strategy board apparatus 1 suited for strategic paintball play, as shown in FIGS. 1-4. The strategy board apparatus 1 comprises a board body 11 and at least one strategy piece 13. The board body 11 comprises a mounting surface 14. The mounting surface 14 traverses along the board body 11. The at least one strategy piece 13 is removably attached and distributed about the mounting surface 14 through a fastening element 15, as shown in FIG. 5. In the preferred embodiment of the present invention, the board body 11 is made out of a durable and lightweight material such as, but not limited to fiberboard, polymer, wood, aluminum, or any other suitable material. In the preferred embodiment of the present invention, the fastening element 15 may take the form of any suitable fastening implement that mounts the at least one strategy piece 13 to the mounting surface 14. In various embodiments, the fastening element 15 may take the form of magnets, hook and loop fasteners, clips, hangers, suction elements, or any other suitable fastening element 15. In the preferred embodiment of the present invention, the mounting surface 14 may take the form of any suitable design that complements and mimics the field layout of a paintball field design. In the preferred embodiment of the present invention, the at least one strategy piece 13 may take the form of various shapes the mimic the cover on a paintball field. In one embodiment, one of the at least strategy piece has a circular shape. In another embodiment, one of the at least strategy piece has a triangular shape. In another embodiment, one of the at least strategy piece has a trapezoidal shape. In another embodiment, one of the at least strategy piece has a rectangular shape. In various embodiments, the at least one strategy piece 13 may take the form of any shape or a combination of shapes.

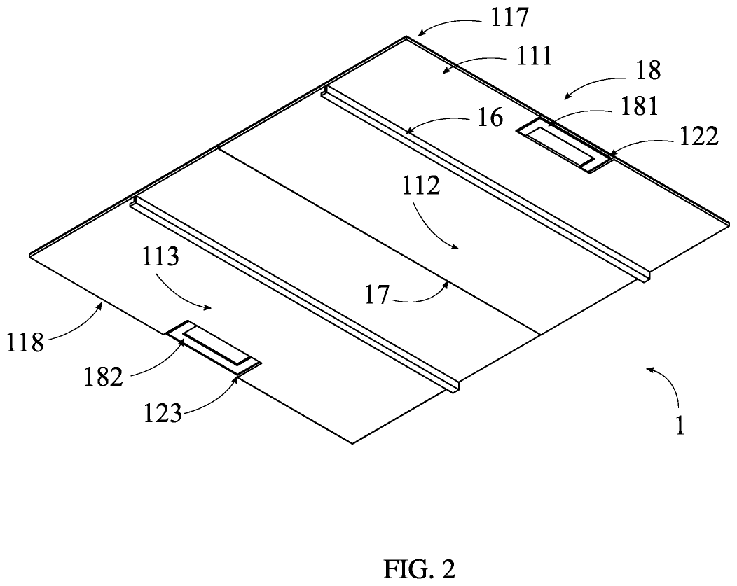

In reference to FIGS. 1-2, the strategy board apparatus 1 further comprises a plurality of mounting elements 16. The board body 11 comprises a base 111. The base 111 traverses along the board body 11, opposite to the mounting surface 14. The plurality of mounting elements 16 is distributed about the base 111. In the preferred embodiment of the present invention, the plurality of mounting elements 16 may take the form of any mounting implement that mounts the strategy board apparatus 1 on any surface or platform. In various embodiments, the plurality of mounting element may take the form of wall hangers, legs, anchors, or any other suitable mounting element.

The board body 11 further comprises a first half 112 and a second half 113, as shown in FIGS. 1-2 and 4. The first half 112 is hingedly connected adjacent to the second half 113 through a connection element 17, as shown in FIG. 2. In the preferred embodiment of the present invention, the board body 11 is constructed out of a first half 112 and a second half 113 hingedly connected through a connection element 17 such that the board body 11 is folded into a compact size. In the preferred embodiment of the present invention, the connection element 17 may take the form of a foldable seam, a set of hinges, or any other suitable connection implement.

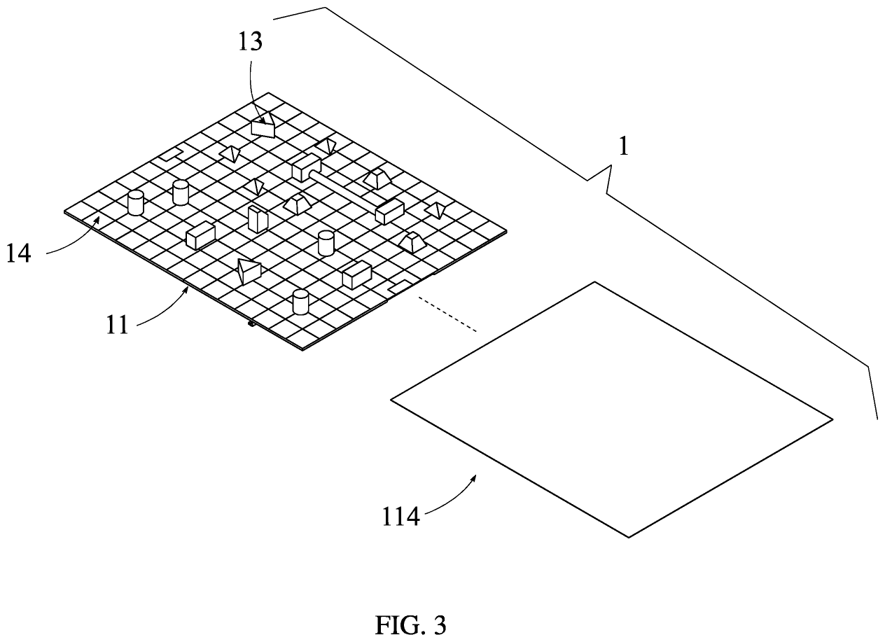

The board body 11 further comprises a magnetic layer 114, as shown in FIG. 3. Each of the at least one strategy piece 13 comprises at least one magnet insert 131, as shown in FIG. 5. The magnetic layer 114 traverses along the board body 11. The at least one magnet insert 131 is positioned within each of the at least one strategy piece 13, where at least one magnet is configured to magnetically attach each of the at least one strategy piece 13 to the mounting surface 14 of the board body 11 or to each other. In the preferred embodiment of the present invention, each of the at least one strategy piece 13 is magnetically attached to the magnetic layer 114, allowing the user to orient the pieces in any fashion that mimics the actual paintball field cover layout. In the preferred embodiment of the present invention, each of the at least one strategy piece 13 is able to connect to each other to form combination field cover in any configuration.

In the preferred embodiment of the present invention, the board body 11 further comprises a drawable layer 115, as shown in FIG. 1. The drawable layer 115 traverses along the mounting surface 14. The drawable layer 115 is made out of a drawable material, such as dry erase laminate but can take form of any other suitable drawable material. The mounting surface 14 comprises a grid pattern 141, as shown in FIG. 1. The grid pattern 141 traverses along the mounting surface 14. In the preferred embodiment of the present invention, the grid pattern 141 may take the form of a square grid where each square is scaled to equal increments that total up to the size of the field. The board body 11 further comprises at least one starting zone 116, as shown in FIG. 1. Each of the at least one starting zone 116 is distributed about the mounting surface 14. In the preferred embodiment of the present invention, each of the at least one starting zone 116 may take the form of pre-marked starting areas along the board body 11. The board body 11 further comprises a first side 117, and a second side 118, as shown in FIGS. 1-2. The first side 117 and the second side 118 are positioned terminally opposite to each other along the mounting surface 14. The board body 11 further comprises a first starting zone 119 and a second starting zone 121, as shown in FIG. 1. The first starting zone 119 is positioned along the first side 117. The second starting zone 121 is positioned along the second side 118. In one embodiment, the board body 11 denotes the first starting zone 119 as the starting zone for one team, while the second starting zone 121 is denoted for the other team.

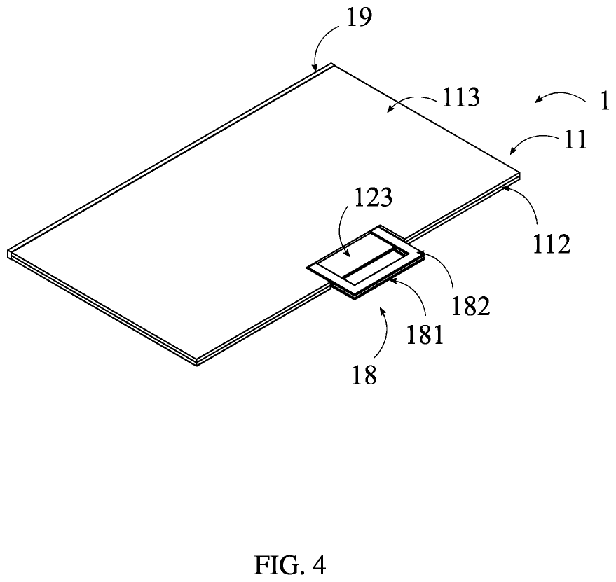

In the preferred embodiment of the present invention, the strategy board apparatus 1 further comprises at least one carrying handle 18, as shown in FIGS. 2 and 4. The at least one carrying handle 18 is connected adjacent to the board body 11. The at least one carrying handle 18 comprises a first handle 181 and a second handle 182, as shown in FIGS. 2 and 4. The first handle 181 is connected adjacent to the first half 112. The second handle 182 is connected adjacent to the second half 113, opposite to the first handle 181, where the second handle 182 is aligned and merged with the first handle 181 when the strategy board assumes a folded configuration. In another embodiment, the board body 11 further comprises a first cavity 122 and a second cavity 123, as shown in FIGS. 2 and 4. The first handle 181 is slidably connected to the first cavity 122. The second handle 182 is slidably connected to the second cavity 123, where the first handle 181 and the second handle 182 is configured to retract or deploy along the first cavity 122 and the second cavity 123. The first half 112 and the second half 113 are removably attached to each other through a locking element 19, as shown in FIG. 4. In the preferred embodiment, the locking element 19 may take the form of a locking block that locks the board in a folded configuration.

Although the invention has been explained in relation to its preferred embodiment, it is to be understood that many other possible modifications and variations can be made without departing from the spirit and scope of the invention as hereinafter claimed.

What is claimed is:

1. A strategy board apparatus comprising:
a board body;
at least one strategy piece;
the board body comprising a mounting surface;
the mounting surface traversing along the board body; and
the at least one strategy piece being removably attached and distributed about the mounting surface through a fastening element.

2. The strategy board apparatus as claimed in claim 1 comprising:
a plurality of mounting elements;
the board body comprising a base;
the base traversing along the board body, opposite to the mounting surface; and
the plurality of mounting elements being distributed about the base.

3. The strategy board apparatus as claimed in claim 1 comprising:
the board body further comprising a first half and a second half; and
the first half being hingedly connected adjacent to the second half through a connection element.

4. The strategy board apparatus as claimed in claim 1 comprising:
the board body further comprising a magnetic layer;
each of the at least one strategy piece comprising at least one magnet insert;
the magnetic layer traversing along the board body; and
the at least one magnet insert being positioned within each of the at least one strategy piece, wherein the at least one magnet is configured to magnetically attach each of the at least one strategy piece to the mounting surface of the board body or to each other.

5. The strategy board apparatus as claimed in claim 1 comprising:
the board body further comprising a drawable layer; and
the drawable layer traversing along the mounting surface.

6. The strategy board apparatus as claimed in claim 1 comprising:
the mounting surface comprising a grid pattern; and
the grid pattern traversing along the mounting surface.

7. The strategy board apparatus as claimed in claim 1 comprising:
the board body further comprising at least one starting zone; and
each of the at least one starting zone being distributed about the mounting surface.

8. The strategy board apparatus as claimed in claim 1 comprising:
the board body further comprising a first side, and a second side; and
the first side and the second side being positioned terminally opposite to each other along the mounting surface.

9. The strategy board apparatus as claimed in claim 8 comprising:
the board body further comprising a first starting zone and a second starting zone;
the first starting zone being positioned along the first side; and
the second starting zone being positioned along the second side.

10. The strategy board apparatus as claimed in claim 1 comprising:
at least one carrying handle; and
the at least one carrying handle being connected adjacent to the board body.

11. The strategy board apparatus as claimed in claim 3 comprising:
at least one carrying handle;
the at least one carrying handle comprising a first handle and a second handle;
the at least one carrying handle being connected adjacent to the board body;
the first handle being connected adjacent to the first half;
the second handle being connected adjacent to the second half, opposite to the first handle, wherein the second handle is aligned and merged with the first handle when the strategy board assumes a folded configuration.

12. The strategy board apparatus as claimed in claim 3 comprising:
at least one carrying handle;
the at least one carrying handle comprising a first handle and a second handle;
the at least one carrying handle being connected adjacent to the board body;
the board body further comprising a first cavity and a second cavity;
the first cavity being positioned adjacent to the first half;
the second handle being positioned adjacent to the second half;
the first handle being slidably connected to the first cavity; and
the second handle being slidably connected to the second cavity, wherein the first handle and the second handle is configured to retract or deploy along the first cavity and the second cavity.

13. The strategy board apparatus as claimed in claim 3 comprising:
the first half and the second half being removably attached to each other through a locking element.

14. The strategy board apparatus as claimed in claim 1, wherein one of the at least strategy piece has a circular shape.

15. The strategy board apparatus as claimed in claim 1, wherein one of the at least strategy piece has a triangular shape.

16. The strategy board apparatus as claimed in claim 1, wherein one of the at least strategy piece has a trapezoidal shape.

17. The strategy board apparatus as claimed in claim 1, wherein one of the at least strategy piece has a rectangular shape.
